(19) United States
(12) Patent Application Publication
(10) Pub. No.: US 2017/0074698 A1
(43) Pub. Date: Mar. 16, 2017

(54) ULTRASONIC METER FOR MEASURING GAS AT SMALLER DIMENSIONS

(71) Applicant: Honeywell International Inc., Morristown, NJ (US)

(72) Inventors: Michael Teufel, Kraichtal-Muenzesheim (DE); Andreas Weber, Huettenberg (DE); Rolf Schmitt, Lambsheim (DE)

(21) Appl. No.: 14/856,212

(22) Filed: Sep. 16, 2015

(51) Int. Cl. G01F 1/66

(52) U.S. Cl. CPC G01F 1/66

(57) ABSTRACT

A system includes a control system and a field device. The control system is configured to communicate data with the field device. The field device includes an ultrasonic meter configured to measure a flow profile of a fluid flow through a pipe using a plurality of ultrasonic transducers. Each of the ultrasonic transducers is configured to transmit an ultrasonic pulse that is reflected and received by each of the other ultrasonic transducers. The field device also includes a network interface configured to output the flow profile to the control system.

### TECHNICAL FIELD

This disclosure is generally directed to ultrasonic flow measurements. More specifically, this disclosure is directed to an ultrasonic meter for gases and for smaller dimensions.

### BACKGROUND

Turbine meters and rotary meters, which are commonly used in industrial control and automation systems, are not always ideal for gas measurements at small flow dimensions. An increasing demand therefore exists for a non-mechanical measurement tool for smaller dimensions that does not present a significant price increase.

### SUMMARY

This disclosure provides an apparatus and method for measuring gas at small dimensions using an ultrasonic meter.

In a first embodiment, a system is provided. The system includes a control system and a field device. The control system is configured to communicate data with one or more field devices. The field device includes an ultrasonic meter configured to measure a flow profile of a fluid flow through a pipe using a plurality of ultrasonic transducers. Each of the ultrasonic transducers is configured to transmit an ultrasonic pulse that is reflected and received by each of the other ultrasonic transducers. The field device further includes a network interface configured to output the flow profile to the control system.

In a second embodiment, a field device is provided. The field device includes an ultrasonic meter configured to measure a flow profile of a fluid flow through a pipe using a plurality of ultrasonic transducers. Each of the ultrasonic transducers is configured to transmit an ultrasonic pulse that is reflected and received by each of the other ultrasonic transducers. The field device further includes a network interface configured to output the flow profile to the control system.

In a third embodiment, a method is provided. The method includes reflecting a first ultrasonic pulse off a wall opposite a first piezo transducer that generates the first ultrasonic pulse. The method also includes measuring a first amount of time for the first ultrasonic pulse to be received by a second piezo transducer and a second amount of time for the first ultrasonic pulse to be received by a fourth piezo transducer. The method further includes reflecting a second ultrasonic pulse off a wall opposite a third piezo transducer that generates the second ultrasonic pulse. The method also includes measuring a third amount of time for the second ultrasonic pulse to be received by the fourth piezo transducer and a fourth amount of time for the second ultrasonic pulse to be received by the second piezo transducer. The method further includes reflecting a third ultrasonic pulse off a wall opposite the second piezo transducer, which generates the pulse signal. The method also includes measuring a fifth amount of time for the third ultrasonic pulse to be received by the first piezo transducer and a sixth amount of time for the third ultrasonic pulse to be received by the third piezo transducer. The method further includes reflecting a fourth ultrasonic pulse off a wall opposite the fourth piezo transducer, which generates the fourth ultrasonic pulse. The method also includes measuring a seventh amount of time for the fourth ultrasonic pulse to be received by the third piezo transducer and an eighth amount of time for the fourth ultrasonic pulse to be received by the first ultrasonic piezo transducer. The method further includes calculating a first velocity based on the first amount of time and the fifth amount of time, a second velocity based on the third amount of time and the seventh amount of time, and a third velocity based on the second amount of time, the fourth amount of time, the sixth amount of time, and the eighth amount of time. The method also includes calculating a flow rate based on the first velocity, the second velocity, and the third velocity.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example industrial control and automation system having a field device according to this disclosure;

FIG. 2 illustrates an field device according to this disclosure;

FIG. 3 illustrates a side cross sectional view showing further details of the field device of FIG. 2 according to this disclosure;

FIG. 4 illustrates a bottom cross sectional view showing further details of the field device of FIG. 2 according to this disclosure; and

FIG. 5 illustrates an example method for measuring smaller dimensions in fluids according to this disclosure.

### DETAILED DESCRIPTION

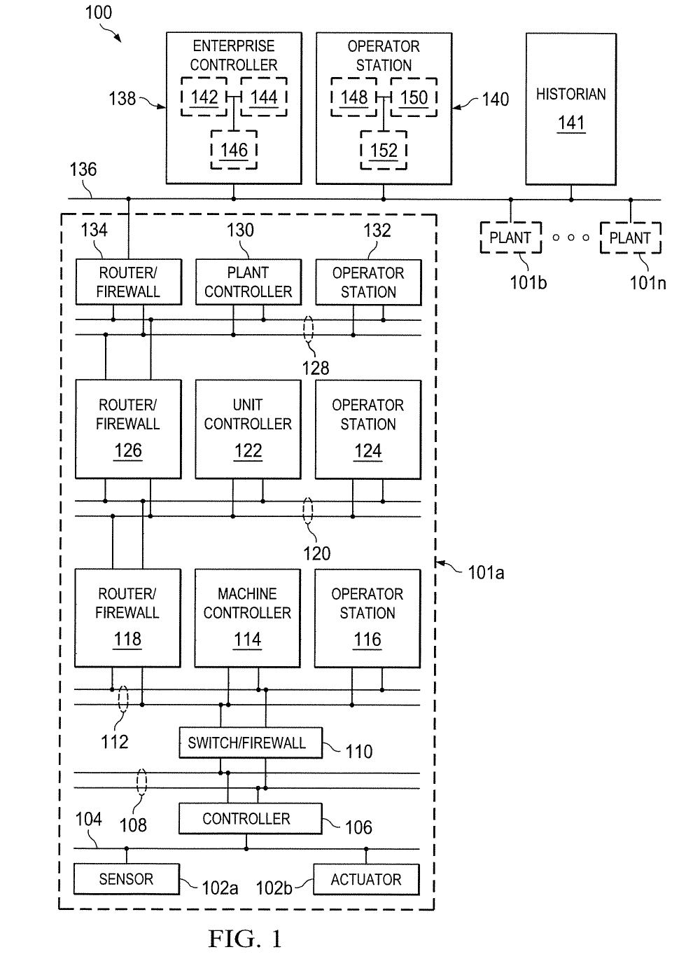

FIGS. 1 through 5, discussed below, and the various examples used to describe the principles of the present invention in this patent document are by way of illustration only and should not be construed in any way to limit the scope of the invention. Those skilled in the art will understand that the principles of the present invention may be implemented in any suitable manner and in any type of suitably arranged device or system.

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an ultrasonic pulse network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Multiple controllers 106 could also operate in redundant configurations, such as when one controller 106 operates as a primary controller while another controller 106 operates as a backup controller (which synchronizes with the primary controller and can take over for the primary controller in the event of a fault with the primary controller). Each controller 106 includes any suitable structure for interacting with one or more sensors 102a and controlling one or more actuators 102b. Each controller 106 could, for example, represent a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as a pair of Ethernet networks or an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as a pair of Ethernet networks or an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers could include one or more processing devices 142 and one or more memories 144 for storing instructions and data used, generated, or collected by the processing device(s) 142. Each of the controllers could also include at least one network interface 146, such as one or more Ethernet interfaces or wireless transceivers. Also, each of the operator stations could include one or more processing devices 148 and one or more memories 150 for storing instructions and data used, generated, or collected by the processing device(s) 148. Each of the operator stations could also include at least one network interface 152, such as one or more Ethernet interfaces or wireless transceivers.

Although FIG. 1 illustrates one example of an industrial process control and automation system 100, various changes may be made to FIG. 1. For example, a control system could include any number of sensors, actuators, controllers, servers, operator stations, and networks. Also, the makeup and arrangement of the system 100 in FIG. 1 is for illustration only. Components could be added, omitted, combined, or placed in any other suitable configuration according to particular needs. Further, particular functions have been described as being performed by particular components of the system 100. This is for illustration only. In general, process control systems are highly configurable and can be configured in any suitable manner according to particular needs.

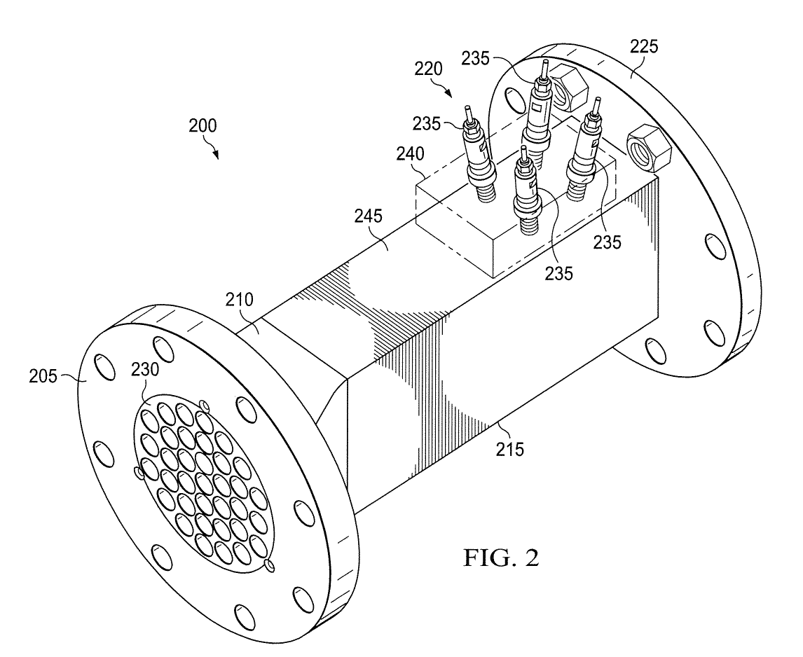

FIG. 2 illustrates a field device 200 according to this disclosure. For ease of explanation, the field device 200 is described as being used in the system 100 of FIG. 1. For example, the field device 200 may represent (or be represented by) a sensor 102a, an actuator 102b, a controller 106, another component, or a combination of components described in FIG. 1. However, the field device 200 could be used in any other suitable system.

The field device 200 includes an upstream connection 205, a nozzle 210, a rectangular channel 215, an ultrasonic meter 220, a downstream connection 225, and a plurality of ultrasonic transducers 235. The field device 200 represents a device or system that is installed in a pipeline for measuring the fluid flow through a pipeline. Relative directions and locations within the field device 200 are described with respect to the direction of the fluid flow, where “upstream” indicates where the fluid flow enters the field device 200 and “downstream” indicates where the fluid flow exits the device. While the illustrated embodiments illustrate fluid flow in a single direction, the field device 200 can measure fluid flow in both directions.

The upstream connection 205 connects to a pipeline to receive a fluid flow from upstream. The upstream connection 205 can include an integrated two-dimensional flow conditioner 230, such as a spool piece, installed in the fluid flow path. The integrated two-dimensional flow conditioner 230 reduces the disturbance of the flow profile for increased accuracy of flow readings from the ultrasonic transducers 235. The downstream connection 225 connects to the downstream pipeline allowing the fluid flow to continue to the intended destination.

After the upstream connection 205, the nozzle 210 converts the fluid flow from a circular profile pipeline to the rectangular channel 215. Along with the integrated two-dimensional flow conditioner 230, the nozzle 210 is designed to reduce the disturbance of the flow profile for increasing the accuracy of the flow readings from the ultrasonic transducers 235. While the nozzle 210 and the integrated two-dimensional flow conditioner 230 are only illustrated between the upstream connection 205 and the rectangular channel 215, a second nozzle and integrated two-dimensional flow conditioner can be included between the rectangular channel 215 and the downstream connection 225.

The rectangular channel 215 provides a conduit for the fluid to flow through in order to be accurately measured by the ultrasonic meter 220. The planar interior surfaces of the rectangular channel 215 provide a more suitable surface for reflecting ultrasonic pulses than rounded surfaces found in many circular channels.

The ultrasonic meter 220 includes the plurality of ultrasonic transducers 235 installed in a housing 240 on the top surface 245 of the rectangular channel 215. While the ultrasonic meter 220 is installed on the top surface 245 in this embodiment, the ultrasonic meter 220 can be installed on any portion of the rectangular channel 215. Furthermore, the depicted embodiment includes four ultrasonic transducers 235, but the present disclosure is not limited to any specific number of ultrasonic transducers. The ultrasonic transducers 235 are installed in the rectangular channel 215 so as to be flush with the planar inside surface of the rectangular channel 215. The ultrasonic transducers 235 are installed in the ultrasonic meter 240 so that ultrasonic pulses (e.g., pulse signals) produced are reflected off the opposite inside surface of the rectangular channel 215 in a manner that all the other ultrasonic transducers can receive the reflected ultrasonic pulses. The housing 240 provides protection and stability and provides for accurate positioning of the ultrasonic transducers 235.

Although FIG. 2 illustrates details of an example field device 200, various changes may be made to FIG. 2. For example, the number(s) and type(s) of components shown in FIG. 2 are for illustration only. Also, the functional divisions of the field device 200 shown in FIG. 2 are for illustration only. Various components in FIG. 2 could be omitted, combined, or further subdivided and additional components could be added according to particular needs.

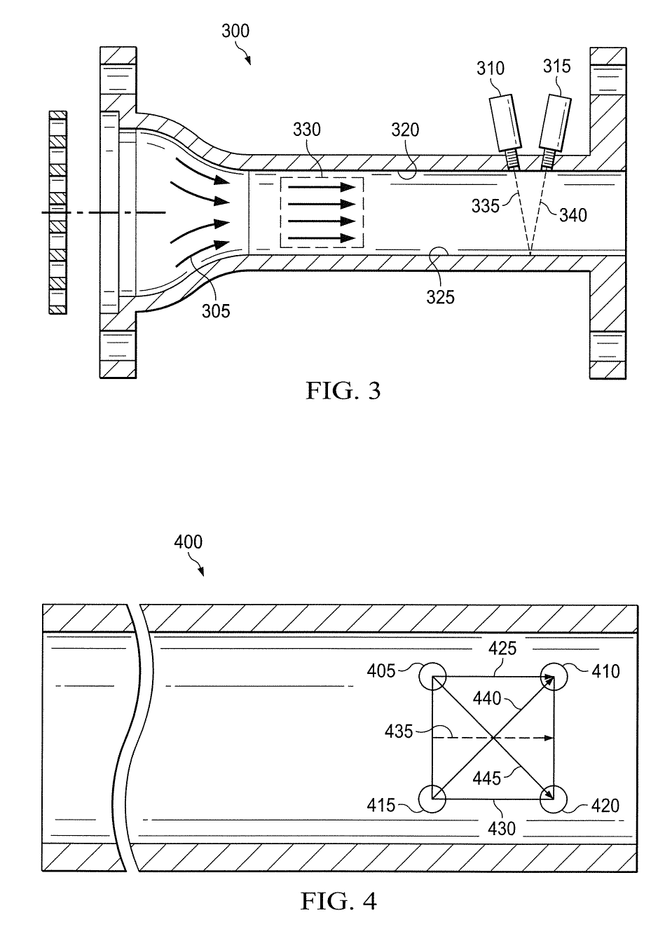

FIG. 3 illustrates a side cross sectional view showing further details of the field device 200 according to this disclosure. In FIG. 3, the fluid flow 305 is from left to right, as indicated by the arrows. While the fluid flow 305 can be measured in either direction, for simplicity, the discussion of measuring the fluid flow 305 will reference the fluid flowing from left to right.

The field device 200 includes a first transducer 310, a second transducer 315, a mounting surface 320, and a reflecting surface 325. The first transducer 310 and the second transducer 320 may represent two of the ultrasonic transducers 235 shown in FIG. 2. The reflecting surface 325 is opposite the mounting surface 320. The transducers 310-315 are mounted flush with the mounting surface 320 so as to not impact or disturb the fluid flow 305. The transducers 310-315 315 are mounted at an angle in a manner that the ultrasonic pulse 335 generated from the first transducer 310 is reflected on the reflecting surface 325 so that a reflected pulse signal 340 is detected by the second transducer 315, and vice versa.

Once the fluid profile 330 of the fluid flow 305 smooths out in the rectangular channel 215, a first transducer 310 transmits the ultrasonic pulse 335 through the fluid flow 305 to the reflecting surface 325 of the rectangular channel 215. The reflected ultrasonic pulse 340 is received and sensed by the second transducer 315. Once the reflected ultrasonic pulse 340 is received, the second transducer 315 generates an ultrasonic pulse to be reflected back to the first transducer 310. The time of travel of the ultrasonic pulses upstream and downstream, along with other factors such as fluid properties and dimensions of the rectangular channel 215, are used to measure the velocity of the fluid flow 305 through the field device 200.

Although FIG. 3 illustrates details for a side cross sectional view of the field device 200, various changes may be made to FIG. 3. For example, the number(s) and type(s) of components shown in FIG. 3 are for illustration only. Also, the functional divisions of the field device 200 are for illustration only. Various components in FIG. 3 could be omitted, combined, or further subdivided and additional components could be added according to particular needs.

FIG. 4 illustrates a bottom cross sectional view showing further details of the field device 200 according to this disclosure. While the fluid flow can be measured in either direction, for simplicity, the discussion of measuring the fluid flow will reference the fluid flowing from left to right.

The field device 200 includes transducer 405, transducer 410, transducer 415, and transducer 420. The transducers 405-420 may represent the ultrasonic transducers 235 shown in FIG. 2. The transducers 405-420 are used to measure the fluid profile through the rectangular channel 215. The fluid profile includes a first flow measurement 425, a second flow measurement 430, and a third flow measurement 435. The first flow measurement 425 is measured based on the amount of time required for the reflection of an ultrasonic pulse generated from the transducer 405 to be received by the transducer 410. The second flow measurement 430 is measured based on the amount of time required for the reflection of an ultrasonic pulse generated from the transducer 415 to be received by the transducer 420. The third flow measurement 435 is calculated from a first cross measurement 440 and a second cross measurement 445. The first cross measurement 440 is measured based on the amount of time required for the reflection of an ultrasonic pulse generated from the transducer 405 to be received by the transducer 420. The second cross measurement 445 is measured based on the amount of time required for the reflection of an ultrasonic pulse generated from transducer 415 to be received by transducer 410. The reflected path configuration compensates for additional “wrong” measurements of transversal velocities, such as swirls.

The velocities for the first flow measurement 425, the second flow measurement 430, the first cross measurement 440, and the second cross measurement 445 can be calculated using equation 1:

$$v = \frac{L}{2 * cos ( α )} * \frac{Δ T}{{T}_{I} * {T}_{+}} \frac{m}{s} \qquad ( eq . 1 )$$

where v is the velocity of the flow measurement, L is the length of the path of the ultrasonic pulse, a is the angle of the path with respect to the pipe, T₋ is the amount of time for the generated ultrasonic pulse traveling downstream to be detected, T₊ is the amount of time for the generated ultrasonic pulse traveling upstream to be detected, and ΔT is the time difference in the between T₋ and T₊.

The velocities for the third flow measurement 435 can be calculated using equation 2:

$${v}_{M} = \frac{{v}_{cm 1} + {v}_{cm 2}}{2} * \sqrt{2} \qquad ( eq . 2 )$$

where v_{M} is the velocity of the third flow measurement 435, v_{cm1} is the velocity for the first cross measurement 440, and v_{cm2} is the velocity for the second cross measurement 445.

The calculation of the mean velocity for the entire profile can, for example, be performed by applying a simple Gauss-Legendre integration with three fixed points. Such a procedure is known in the standard literature.

The flow rate Q is calculated by multiplying the mean velocity with the rectangular cross section using equation 3:

Q=v_{M}*A (eq. 3)

where Q is the flow rate, vₘ is the average velocity, A is the area of the cross section of the rectangular channel (A=h*D), h is the height of the rectangular channel, and D is the depth of the rectangular channel.

Although FIG. 4 illustrates details for a cross sectional view of the field device 200, various changes may be made to FIG. 4. For example, the number(s) and type(s) of components shown in FIG. 4 are for illustration only. Also, the functional divisions of the field device 200 are for illustration only. Various components in FIG. 4 could be omitted, combined, or further subdivided and additional components could be added according to particular needs.

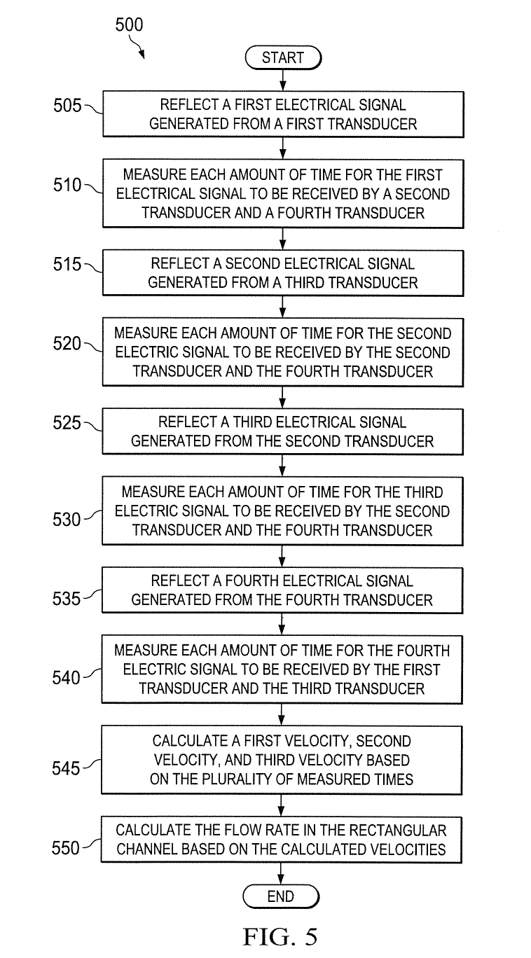

FIG. 5 illustrates an example method for measuring smaller dimensions in fluids according to this disclosure. For ease of explanation, the method 500 is described with respect to the field device 200 shown in FIGS. 2 through 4. However, the method 500 could be used by any suitable field device and in any suitable system.

In block 505, the system reflects a first ultrasonic pulse off a wall opposite a first ultrasonic transducer, which generates the pulse signal. In block 510, the system measures a first amount of time for the first ultrasonic pulse to be received by a second ultrasonic transducer and a second amount of time for the ultrasonic pulse to be received by a fourth ultrasonic transducer. The measured amount of time is greater when the fluid flow is generally in the same direction as the ultrasonic pulse and lesser when the fluid flow is generally opposite the direction of the ultrasonic pulse.

In block 515, the system reflects a second ultrasonic pulse off a wall opposite a third transducer, which generates the pulse signal. In block 520, the system measures a third amount of time for the second ultrasonic pulse to be received by the fourth ultrasonic transducer and a fourth amount of time for the ultrasonic pulse to be received by the second ultrasonic transducer.

In block 525, the system reflects a third ultrasonic pulse off a wall opposite the second transducer, which generates the pulse signal. In block 530, the system measures a fifth amount of time for the third ultrasonic pulse to be received by the first ultrasonic transducer and a sixth amount of time for the ultrasonic pulse to be received by the third ultrasonic transducer.

In block 535, the system reflects a fourth ultrasonic pulse off a wall opposite the fourth transducer, which generates the pulse signal. In block 540, the system measures a seventh amount of time for the fourth ultrasonic pulse to be received by the third ultrasonic transducer and an eighth amount of time for the ultrasonic pulse to be received by the first ultrasonic transducer;

In block 545, the system calculates a first velocity based on the first amount of time and the fifth amount of time, a second velocity based on the third amount of time and the seventh amount of time, and a third velocity based on the second amount of time, the fourth amount of time, the sixth amount of time, and the eighth amount of time. In block 550, the system calculates a flow rate based on the first velocity, the second velocity, and the third velocity.

In some embodiments, one or more of the ultrasonic transducers may be piezo transducers.

Although FIG. 5 illustrates one example of a method 500 for measuring smaller dimensions in fluids, various changes may be made to FIG. 5. For example, while shown as a series of steps, various steps shown in FIG. 5 could overlap, occur in parallel, or occur multiple times. Moreover, some steps could be combined or removed and additional steps could be added.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims is intended to invoke 35 U.S.C. §112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. §112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system comprising:
a control system configured to communicate data with one or more field devices; and
a field device comprising:
an ultrasonic meter configured to measure a flow profile of a fluid flow through a pipe using a plurality of ultrasonic transducers, wherein each of the ultrasonic transducers is configured to transmit an ultrasonic pulse that is reflected and received by each of the other ultrasonic transducers; and
a network interface configured to output the flow profile to the control system.

2. The system of claim 1, wherein the ultrasonic meter comprises four ultrasonic transducers.

3. The system of claim 2, wherein the four ultrasonic transducers are disposed in the ultrasonic meter in a rectangular arrangement.

4. The system of claim 1, wherein the field device further comprises a rectangular channel configured to contain the fluid flow past the plurality of ultrasonic transducers.

5. The system of claim 4, wherein the plurality of ultrasonic transducers are all disposed on a single side of the rectangular channel.

6. The system of claim 4, wherein the field device further comprises a nozzle at an entrance configured to transition the fluid flow from a circular pipe to the rectangular channel.

7. The system of claim 1, wherein the field device further comprises an integrated two-dimensional flow conditioner configured to reduce disturbance in the fluid flow profile.

8. A field device comprising:
an ultrasonic meter configured to measure a flow profile of a fluid flow through a pipe using a plurality of ultrasonic transducers, wherein each of the ultrasonic transducers is configured to transmit an ultrasonic pulse that is reflected and received by each of the other ultrasonic transducers; and
a network interface configured to output the flow profile to the control system.

9. The field device of claim 8, wherein the ultrasonic meter comprises four ultrasonic transducers.

10. The field device of claim 9, wherein the four ultrasonic transducers are disposed in the ultrasonic meter in a rectangular arrangement.

11. The field device of claim 8, wherein the field device further comprises a rectangular channel configured to contain the fluid flow past the plurality of ultrasonic transducers.

12. The field device of claim 11, wherein the plurality of ultrasonic transducers are all disposed on a single side of the rectangular channel.

13. The field device of claim 11, wherein the field device further comprises a nozzle at an entrance configured to transition the fluid flow from a circular pipe to the rectangular channel.

14. The field device of claim 8, wherein the field device further comprises an integrated two-dimensional flow conditioner configured to reduce disturbance in the fluid flow profile.

15. A method comprising:
reflecting a first ultrasonic pulse off a wall opposite a first piezo transducer that generates the first ultrasonic pulse;
measuring a first amount of time for the first ultrasonic pulse to be received by a second piezo transducer and a second amount of time for the first ultrasonic pulse to be received by a fourth piezo transducer;
reflecting a second ultrasonic pulse off a wall opposite a third piezo transducer that generates the second ultrasonic pulse;
measuring a third amount of time for the second ultrasonic pulse to be received by the fourth piezo transducer and a fourth amount of time for the second ultrasonic pulse to be received by the second piezo transducer;
reflecting a third ultrasonic pulse off a wall opposite the second piezo transducer that generates the third ultrasonic pulse;
measuring a fifth amount of time for the third ultrasonic pulse to be received by the first piezo transducer and a sixth amount of time for the third ultrasonic pulse to be received by the third piezo transducer;
reflecting a fourth ultrasonic pulse off a wall opposite the fourth piezo transducer that generates the fourth ultrasonic pulse;
measuring a seventh amount of time for the fourth ultrasonic pulse to be received by the third piezo transducer and an eighth amount of time for the fourth ultrasonic pulse to be received by the first piezo transducer;
calculating a first velocity based on the first amount of time and the fifth amount of time, a second velocity based on the third amount of time and the seventh amount of time, and a third velocity based on the second amount of time, the fourth amount of time, the sixth amount of time, and the eighth amount of time; and
calculating a flow rate based on the first velocity, the second velocity, and the third velocity.

16. The method of claim 15, wherein the first piezo transducer, the second piezo transducer, the third piezo transducer, and the fourth piezo transducer are disposed in a rectangular arrangement.

17. The method of claim 15, wherein the first piezo transducer, the second piezo transducer, the third piezo transducer, and the fourth piezo transducer are disposed in a rectangular channel configured to contain fluid flow.

18. The method of claim 17, wherein the first piezo transducer, the second piezo transducer, the third piezo transducer, and the fourth piezo transducer are all disposed on a single side of the rectangular channel.

19. The method of claim 17, wherein a nozzle is disposed at an entrance to the rectangular channel and configured to transition the fluid flow from a circular pipe to the rectangular channel.

20. The method of claim 17, wherein an integrated two-dimensional flow conditioner is configured to reduce disturbance in the flow profile.
